(19) United States
(12) Patent Application Publication
(10) Pub. No.: US 2004/0255873 A1
(43) Pub. Date: Dec. 23, 2004

(54) System and method for effervescent fuel atomization

(75) Inventors: Michael Kent Cueman, Niskayuna, NY (US); Roy James Primus, Schenectady, NY (US)

Correspondence Address: General Electric Company, CRD Patent Docket Rm 4A59, Bldg. K-1, P.O. Box 8, Schenectady, NY, 12301, US

(73) Assignee: General Electric Company

(21) Appl. No.: 10/602,263

(22) Filed: Jun. 23, 2003

(51) Int. Cl. F02B 75/12

(52) U.S. Cl. 123/1 A

(57) ABSTRACT

A system and method are provided for atomization and combustion. The system and method include mixing a volume of liquid fuel with a volume of a corresponding soluble gas to create a liquid fuel/dissolved gas mixture, and pressurizing the resulting liquid fuel/dissolved gas mixture. The liquid fuel/dissolved gas mixture is discharged through a discharge opening in fluid communication with a lower pressure chamber forming droplets of the liquid fuel/dissolved gas mixture, wherein the soluble gas emerges from solution further breaking up the droplets forming smaller droplets for promoting combustion of the smaller droplets in the chamber.

### BACKGROUND OF THE INVENTION

The invention relates generally to a system and method to enhance atomization of liquid fuel for combustion. In particular, the invention relates to such a liquid fuel in which a gas is mixed with the fuel to obtain improved atomization of the fuel being injected for combustion.

The system and method of this invention may be used to advantage in diesel fuel engines, and especially locomotive engines, as well as any other reciprocating engine, furnace, turbine, or combustor of liquid fuel where the atomization of liquid fuel is desired.

Modern engines typically use some form of pressurized fuel injector to spray fuel into the combustion air either in the inlet port or directly in the combustion chamber. High injection pressures, small spray holes and high momentum air flows are used to generate small drops and more nearly homogeneous mixtures. Unfortunately, the drop sizes do not decrease linearly with increasingly demanding use of these existing techniques.

In a diesel engine, for example, liquid fuel is injected into a plurality of engine cylinders full of compressed air at high temperature. The fuel is broken up into droplets, which evaporate and mix with the air in the cylinders to form a flammable mixture. Traditional concerns for diesel engine manufacturers include fuel efficiency and smokeless operation, both of which relate to the quality of combustion in the cylinders.

With the imposing of more stringent diesel engine emissions regulations, high efficiency atomization of the fuel is necessary to produce combustion with the required low levels of emissions. One key measure of spray quality is the Sauter Mean Diameter (SMD) of the spray droplets, with respect to which the smaller the SMD, the better the spray quality with spray droplet sizes in the range of 5-6 micron SMD being sought. Unfortunately, to achieve a spray with droplets of such a size, current liquid fuel injection systems demand extremely high pressures, unique materials and expensive manufacturing techniques.

Liquid fuel injection systems have long been known and used to increase the efficiency of internal combustion engines. In such systems, volatile liquid fuels are atomized into a finely divided spray of small droplets upon being introduced into the combustion space. The fuel injection process is important in determining the nature of the subsequent combustion because the combustion reaction is quite dependent upon the homogeneous mixture of fuel and air and the gasification of fuel droplets in the combustion space. The efficiency of the combustion process in engines in the present day has assumed greater importance than in the past and will continue to do so because of the diminishing quality of fuels and the increasing environmental concerns about and regulation of exhaust pollutants released into the ambient atmosphere by inefficient combustion reactions.

The traditional and most generally used type of fuel injector employs plain orifice atomization wherein a low viscosity liquid is passed through a small circular hole under pressure which exceeds the combustion chamber pressure by a sufficient amount, about twenty thousand pounds per square inch, so that the emerging fluid jet will disintegrate into an atomized spray. The physical reactions involved have been extensively studied but notwithstanding there is no general agreement on the detailed nature of this atomization process, though undoubtedly the process involves turbulence or unstable vibrations at the interface of an emerging fluidic jet and the surrounding gaseous atmosphere, whether this occurs within a nozzle, at its orifice or spacedly outwardly from the orifice. Regardless of the detailed nature of the physical reactions involved in the atomization process, plain orifice atomizers have fundamental limitations of low dispersement cone angles and long jet breakup lengths, both of which may be somewhat alterable but remain in their essence in all such devices, with dispersement cone angles usually not surpassing about fifteen degrees, even at very large Reynolds numbers. With such narrow dispersement cone angles, and notwithstanding a plurality of nozzles, generally fuel cannot be operatively delivered homogenously to an entire combustion chamber volume and the inherent limitations of time and distance required to develop instabilities that cause atomization merely accentuate this problem. It thusly appears that with plain orifice atomizers the essential nature of their operation requires that a fuel-air mixture in a combustion chamber will remain non-homogeneous with both fuel rich and fuel lean areas simultaneously existing within a cylinder.

Thus, a need exists for a system and method of fuel injection which can obtain the desired degree of atomization without operating at increased pressures, so that manufacturing costs can be reduced yet still meeting emissions requirements while producing fine drops and more nearly homogeneous fuel air mixtures.

### BRIEF SUMMARY OF THE INVENTION

The above discussed and other drawbacks and deficiencies of the prior art are overcome or alleviated by a system and method of producing fine drops and more nearly homogeneous fuel air mixtures for combustion thereof, particularly in an internal combustion engine.

In one aspect of the present invention, a significant quantity of gas which is naturally soluble in the liquid fuel is introduced into the fuel when both are under pressure. The fuel and dissolved gas may be metered through a conventional fuel injection nozzle of an injector into a combustion chamber, cylinder, manifold or combustor where it is to be mixed with air. This injector breaks the fuel mixture into droplets in the conventional way. However, the dramatic pressure reduction at the nozzle also permits the gas entrained in the liquid fuel to erupt from solution. The rapidly escaping dissolved gas further breaks up the fuel droplets and results in a finer mist that contributes to the creation of a more homogeneous mixture.

In another aspect of the present invention, this is accomplished by providing an atomization system that includes a flow conduit for flowing a liquid fuel/dissolved gas mixture to a downstream object of interest. The flow conduit defines a flow chamber between a supply of the liquid fuel/dissolved gas mixture with an atomizer/injector located in a combustion chamber downstream. The fuel/dissolved gas mixture is in the liquid phase as it flows through the conduit to the injector, effective atomization occurs as the mixture is flowed downstream out of the injector at the nozzle permitting the gas entrained in the liquid fuel to erupt from solution. The rapidly escaping dissolved gas further breaks up the fuel droplets and results in a finer mist that contributes to the creation of a more homogeneous mixture.

The foregoing and other aspects will become apparent from the following detailed description of the invention when considered in conjunction with the accompanying drawing figures.

### BRIEF DESCRIPTION OF THE DRAWINGS

Referring to the exemplary drawings wherein like elements are numbered alike in the several Figures:

FIG. 1 is a schematic representation of a system that generally includes the atomization system of the present invention in conjunction with a combustor and turbine;

FIG. 2 is a sketch showing another embodiment of an automization system of the present invention in conjunction with an internal combustion chamber of an engine;

FIG. 3 is a sketch illustrating effervescent fuel atomization within the combustion chamber of FIG. 2; and

FIG. 4 is a flow chart representation of the operation of the system of FIG. 1.

### DETAILED DESCRIPTION OF THE INVENTION

The liquid fuel of an internal combustion engine must be mixed with air so that it can be quickly and cleanly burned to produce power. This invention provides a new means to more efficiently disburse the liquid fuel into small drops to enhance evaporation and mixing. This can be used to produce more homogeneous combustion mixtures. More nearly homogeneous mixtures of fuel and air can be used to produce lower emissions and more power.

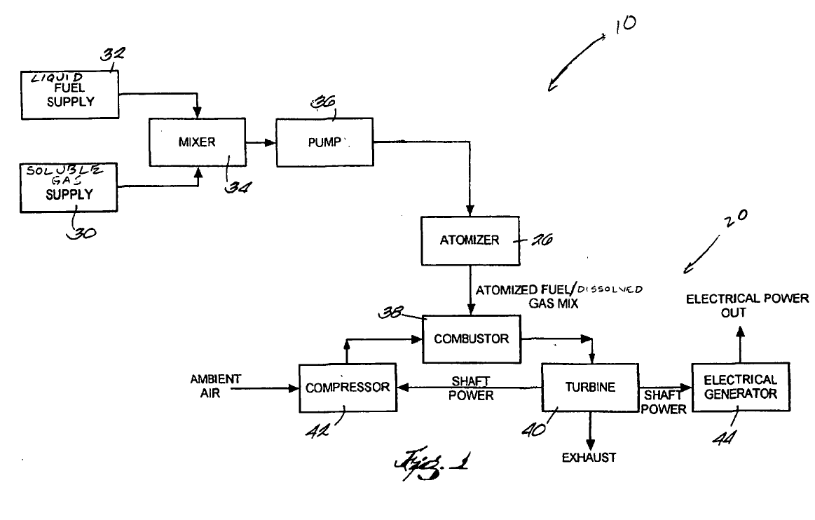

Turning now to the drawings wherein like parts are referred to by the same number throughout the several views, FIG. 1 is a schematic representation of an atomization system 10 that is in operable communication with a combustion system.

Generally in system 10, a volume of a soluble gas is supplied from conventional storage tank 30 and a volume of liquid fuel is supplied from a conventional fuel storage vessel 32 to a conventional mixing device 34. The soluble gas may be any suitable gas that is dissolvable in the liquid fuel, such as but not limited to, a non-polar gas soluble with a hydrocarbon based fuel. In other words, the dissolved gas and host solvent (i.e., liquid fuel) have similar polarity and therefore mutual solubility. However, for purposes of describing an exemplary embodiment of the invention, the gas mixed with the hydrocarbon based fuel is a non-polar gas, such as, but not limited to, NO, H₂, O₂, N₂, He, and Ar. Storage tank 30 includes the requisite valves and other conventional flow regulating devices and mechanisms that are adapted to ensure the correct volume of soluble gas is supplied from the storage tank 30 to mixing device 34. Such valves and flow control devices are well known to one skilled in the art and therefore further description of these devices is not required. These flow control devices may be electrically connected to and actuated by a microprocessor based controller (not shown).

The fuel that is mixed with the soluble gas in mixer 34 may be any suitable combustible fuel such as but not limited to fuel oil, gasoline or diesel fuel, and the storage device may be any vessel that is suitable for storing and dispensing the mixing fuel such as a fuel tank or hopper, for example. Like tank 30, fuel storage vessel 32 includes the requisite valves and/or flow and dispensing apparatus required to ensure the requisite volume of fuel is dispensed to the mixer 34 which may be electrically actuated by a conventional microprocessor based controller. These valves, flow and dispensing devices are well known in the art and therefore do not need to be discussed in further detail hereinafter. For purposes of an exemplary embodiment the fuel will be diesel fuel.

Mixer 34 may be any mixing device suitable to mix a gas and liquid fuel such as a porous medium, a nozzle or a physical agitator. The mixer is flow connected to the fuel tank and liquid tank by suitable piping.

A pump 36 is flow connected to mixer 34 and an atomizer 26. The mixture of liquid fuel and gas is pumped by conventional pump 36 from the mixer 34 to the atomizer 26. The pump may be any suitable pump such as a centrifugal pump for example. Pump 36 may also be located upstream in the system as illustrated in FIG. 2 to pressurize the liquid fuel and gas mixture.

In one embodiment, for example, the atomized mixture of fuel and dissolved gas is delivered from atomizer 26 to a combustor 38 which burns the fuel and the heat energy produced by the combustor is delivered to turbine 40 and is used to drive a turbine 40 or another object of interest.

Operation of combustion within the system 10 will be described in further detail below.

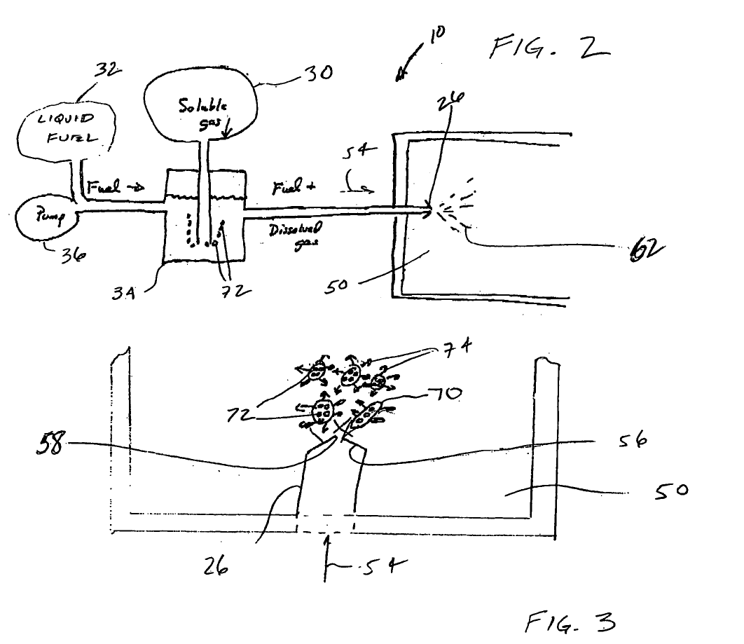

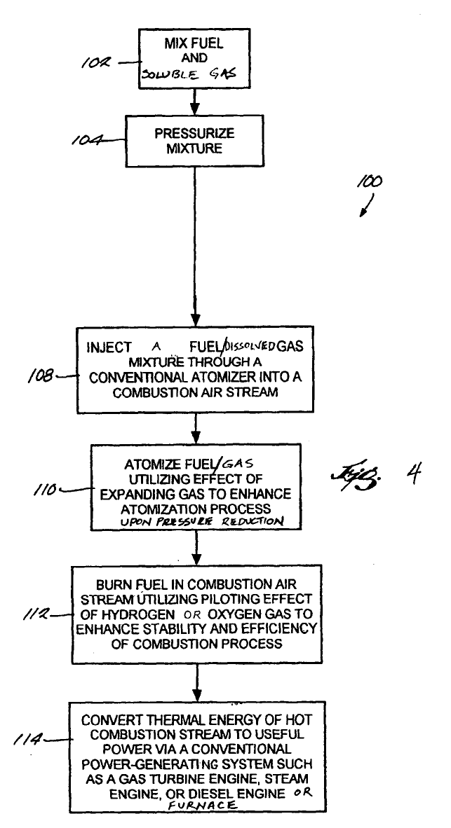

Turning now to FIGS. 2 and 3, another exemplary embodiment of an atomization system of the present invention 10 is illustrated in greater detail. FIG. 2 shows atomizer 26 disposed within a combustion chamber 50. Combustion chamber 50 may be a combustion chamber disposed in, but not limited to, a furnace, internal combustion engine, or even a gas grill. For purposes of an exemplary embodiment the combustion chamber is depicted in an internal combustion chamber defined by a cylinder 52 for combustion of diesel fuel therein, for example.

FIG. 3 illustrates a portion downstream of the system 10 in more detail where a conventional atomizer 26 may be employed, which may be an effervescent diesel type injector. The liquid fuel and dissolved gas mixture flows to the atomizer 26 in the direction of arrows 54 (FIGS. 2 and 3), through peripheral inlet openings (not shown) spaced around the atomizer housing, through the swirl chamber 56, out the discharge orifice 58 and into combustor 38 (FIG. 1) or combustion chamber 50 (FIG. 2) where the fuel is burned. The atomized spray 62 is discharged in a conical configuration as shown in FIG. 2.

When the atomized spray emerges from orifice 58 into chamber 50 with reference to FIG. 3, the liquid fuel and gas mixture droplets indicated generally at 70 experience a reduction in pressure in chamber 50. The reduced pressure allows the dissolved gas indicated generally at 72 to emerge violently out of solution (with “solution” defined as the mixture of liquid fuel and dissolved gas emerging from orifice 58) indicated generally with arrows 74, thus further breaking up the droplets 70 of fuel atomized by atomizer 26.

Operation of the system 10 will now be described with reference to FIG. 4.

Referring to FIG. 4, in block 102, a host liquid fuel and a corresponding soluble gas is supplied to and is mixed by conventional mixer 34 and then in block 104 the fuel/gas mixture is pressurized by pump 36 and is directed into the atomizer 26 as a fuel/gas liquid mixture, upstream from combustion chamber 50.

As the liquid mixture passes downstream toward combustion chamber 50, at block 108 the liquid flow stream leaving the mixer 34 enters the atomizer. The atomizer 26 serves to produce atomization of the mixture. The atomizer, which can be designed in accordance with conventional practice, provides swirling motion to the flow so that the mixture exits in the form of a conical spray 62. The spray 62 consists of a cloud of small fuel droplets interspersed with a stoichiometric mixture of gaseous hydrogen or oxygen, for example, however, any corresponding soluble gas may be dispersed therein as discussed above. The dispersed bubbles of dissolved gas in the spray expand rapidly causing effective atomization of the liquid into further smaller droplets to enhance homogeneous mixture within chamber 50.

The atomization is provided at block 110 and the atomized fuel/gas mixture is injected into the conventional combustor 50 at block 112 where the fuel is burned. Combustion may also occur in a diesel engine, boiler, furnace or any other device when fuel is burned in air.

The presence of highly reactive hydrogen, for example, considerably reduces the difficulty of achieving reliable ignition of the fuel spray in the combustor or combustion chamber. Once the ignition occurs, the small amount of hydrogen flow promotes stable sustained combustion of the fuel by acting as a continuous high temperature pilot for the combustion. This effect is also available by the additional presence of pure oxygen when oxygen is dissolved in the liquid fuel. Additionally, it will be recognized with reference to FIG. 1 that a conventional compressor 42 supplies high pressure ambient air into the combustor to provide the main source of air for the combustion process.

The heat energy produced by the combustor is used to drive compressor 42 and another object of interest such as an electrical generator 44 for example. See block 114.

In summary, a significant quantity of gas which in naturally soluble in the liquid fuel is introduced into the fuel when both are under pressure. The fuel and dissolved gas is metered through a conventional fuel injection nozzle of an atomizer into the cylinder, manifold or combustor where it is to be mixed with air. The injector or atomizer breaks the fuel mixture into droplets in the conventional way. However, the dramatic pressure reduction at the nozzle also permits the gas entrained in the liquid fuel to erupt from solution. The rapidly escaping dissolved gas further breaks up the fuel droplets and results in a finer mist that contributes to the creation of a more homogeneous mixture.

Thus, one skilled in the pertinent art will recognize that one key to this invention is the use of a gas that has substantial solubility in the liquid fuel to be atomized. Non-polar gas molecules (e.g., NO, H₂, O₂, N₂, He, and Ar) are non-limiting examples of materials to be used with petroleum fuels.

The above described system and method provides a new mechanism for breaking up fuel droplets. The system and method supplement the fuel injection techniques already in use. The disclosed system and method may be used to improve fuel atomization and mixing or to reduce the injection pressure requirements for a desired fuel dispersion.

The invention disclosed hereinabove, addresses a number of the major problems which hinder the effective atomization of fuel injected fuels. Additionally, combustion in the present invention is achieved with greater efficiency and stability than with conventional systems by producing finer droplets of fuel that more nearly approach homogeneous fuel air mixtures.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of atomization and combustion, the method comprising:
mixing a volume of liquid fuel with a volume of a corresponding soluble gas to create a liquid fuel/dissolved gas mixture;
pressurizing the liquid fuel/dissolved gas mixture;
discharging the liquid fuel/dissolved gas mixture through a discharge opening in fluid communication with a lower pressure chamber forming droplets of the liquid fuel/dissolved gas mixture, wherein said soluble gas emerges from solution further breaking up the droplets forming smaller droplets; and
combusting the smaller droplets in the chamber.

2. The method of claim 1 wherein the dissolved gas and liquid fuel have similar polarity providing mutual solubility with one another.

3. The method of claim 1 wherein the liquid fuel is a hydrocarbon based fuel and the soluble gas is one of NO, O₂, N₂, He, and Ar.

4. The method of claim 3 wherein the liquid fuel is diesel fuel.

5. The method of claim 3 wherein said chamber is a combustion chamber in an internal combustion engine.

6. The method of claim 1 herein said chamber is a combustion chamber in one of a furnace, cylinder of an internal combustion engine, a combustor for a turbine, or any other device where fuel is burned in air.

7. The method of claim 1 wherein said discharge opening includes a nozzle of a fuel injector.

8. The method of claim 7 wherein the fuel injector is configured to break the liquid fuel/dissolved gas mixture into said droplets.

9. The method of claim 8 wherein said chamber is a combustion chamber in a locomotive.

10. The method of claim 8 wherein said discharge opening is disposed in one of a cylinder, a manifold, and a combustor.

11. The method of claim 1 wherein the mixing said volume of liquid fuel with said volume of said corresponding soluble gas is done when both are under pressure.

12. The method of claim 1 further comprising:
operatively connecting an air supply to the chamber, said air supply configured to flow high pressure air into said chamber to promote said combustion.

13. A system for atomization and combustion, the system comprising:
a mixer for mixing a volume of liquid fuel with a volume of a corresponding soluble gas to create a liquid fuel/dissolved gas mixture;
a combustion chamber in fluid communication with said mixer; and
an atomization system connected to the mixer downstream from the mixer and to the combustion chamber upstream from the combustion chamber, the atomization system including an atomizer having a discharge opening configured to discharge the atomized liquid fuel/dissolved gas mixture through a discharge opening in fluid communication with said chamber having a lower pressure forming droplets of the liquid fuel/dissolved gas mixture, wherein said soluble gas emerges from solution further breaking up the droplets forming smaller droplets for combustion in said chamber.

14. The system of claim 13 wherein the system further comprises a pump connected to the mixer and the atomization system, to pressurize the mixture and force the mixture downstream to the atomization system.

15. The system of claim 13 wherein the soluble gas and liquid fuel have similar polarity providing mutual solubility with one another.

16. The system of claim 13 wherein the liquid fuel is a hydrocarbon based fuel and the soluble gas is one of NO, O₂, N₂, He, and Ar.

17. The system of claim 16 wherein the liquid fuel is diesel fuel.

18. The system of claim 16 wherein said chamber is a combustion chamber in an internal combustion engine.

19. The system of claim 13 herein said chamber is a combustion chamber in one of a furnace, cylinder of an internal combustion engine, a combustor for a turbine, or any other device where fuel is burned in air.

20. The system of claim 13 wherein said discharge opening includes a nozzle of a fuel injector.

21. The system of claim 20 wherein the fuel injector is configured to break the liquid fuel/dissolved gas mixture into said droplets.

22. The system of claim 20 wherein said discharge opening is disposed in one of a cylinder, a manifold, and a combustor.

23. The system of claim 13 further comprising a pump for pressurizing the liquid fuel and soluble gas during mixing.

24. The system of claim 13 further comprising:
an air supply operatively connected to the chamber, said air supply configured to flow high pressure air into said chamber to promote said combustion.

25. A diesel locomotive internal combustion engine comprising at least two cylinders, each having a reciprocating piston operatively connected to a crank and a combustion chamber, also comprising means for injecting a liquid fuel into the combustion chambers of an internal combustion diesel engine comprising:
a means for mixing a volume of the liquid fuel with a volume of a corresponding soluble gas to create a liquid fuel/dissolved gas mixture;
a means for pressurizing a resulting liquid fuel/dissolved gas mixture; and
a means for discharging the liquid fuel/dissolved gas mixture through a discharge opening in fluid communication with each chamber having lower pressure forming droplets of the liquid fuel/dissolved gas mixture, wherein said soluble gas emerges from solution further breaking up the droplets forming smaller droplets configured to promote combustion of the smaller droplets in the chamber.
